(19) United States
(12) Patent Application Publication
(10) Pub. No.: US 2026/0006438 A1
(43) Pub. Date: Jan. 1, 2026

(54) METHODS AND DEVICES FOR SUPPORTING AUTHENTICATION

(71) Applicant: Telefonaktiebolaget LM Ericsson (publ), Stockholm (SE)

(72) Inventors: Carlo Giovanni Perocchio, Santa Margherita Ligure (IT); Gianmarco Bruno, Genova (IT)

(21) Appl. No.: 18/879,881

(22) PCT Filed: Jun. 30, 2022
(86) PCT No.: PCT/EP2022/068163

§ 371 Date: Dec. 30, 2024

(51) Int. Cl. H04W 12/06; H04L 9/40

(52) U.S. Cl. CPC H04W 12/06; H04L 63/0861

(57) ABSTRACT

Methods and devices for supporting authentication of a user to a service provided by a second communication device, wherein a first communication device sends to the second communication device a request for the user to access the service, wherein the request comprises credentials of the user. The first communication device receives inference biometric data of the user from the second communication device; determines whether the user can be authenticated using a machine learning, ML, model trained for classifying biometric data of the user and the received inference biometric data as input; and in response thereto, sends to the second communication device a message indicative of a confirmation or a rejection of the authentication of the user.

### TECHNICAL FIELD

The invention relates to methods for supporting authentication of a user, a first communication device for supporting authentication of a user, a second communication device for supporting authentication of a user, and corresponding computer programs and computer program products.

### BACKGROUND

An authentication factor is a category of security credential that is used to verify identity and authorization of a user attempting to gain access, engage in communications, or request data from a secured network, system, or application. Authentication factors include something a user “has”, such as a one-time-use token, a smartcard, or some other artifact in physical possession of the user; something the user “knows”, such as a password, a personal identification number (PIN), or some other personal information; and something the user “is”, i.e., biometric data. The biometric data comprises distinctive, measurable characteristics used to label and describe individuals. Unique biological traits such as retinas, irises, voices, facial characteristics, and fingerprints, may be used for a user identity verification in a security process.

Biometric authentication can be used as form of identification and access control in a biometric system wherein a user is enrolled by providing biometric samples. Upon an authentication attempt by the user, the system decides whether the provided biometric sample is similar enough to stored reference samples. Authentication is granted only in case of a successful match.

### SUMMARY

An object of the invention is to provide an improved alternative to the above techniques and prior art. More specifically, it is an object of the invention to provide improved authentication of a user to a service. This and other objects of the invention are achieved by means of different aspects of the invention, as defined by the independent claims. Embodiments of the invention are characterized by the dependent claims.

According to a first aspect of the invention, a method for supporting authentication of a user to a service provided by a second communication device is provided. The method is performed by a first communication device. The method comprises sending to the second communication device a request for accessing the service. The request comprises credentials of the user. The method further comprises receiving inference biometric data of the user from the second communication device. The method further comprises determining whether the user can be authenticated using a machine learning, ML, model trained for classifying biometric data of the user and the received inference biometric data as input. The method further comprises, in response thereto, sending to the second communication device a message indicative of a confirmation or a rejection of the authentication of the user.

According to a second aspect of the invention, a method for supporting authentication of a user to a service provided by a second communication device is provided. The method is performed by the second communication device. The method comprises receiving, from a first communication device, a request for accessing the service. The request comprises credentials of the user. The method further comprises obtaining inference biometric data of the user from a sensor adapted to capture biometric data from the user, in response to a successful verification of the credentials of the user. The method further comprises sending the inference biometric data to the first communication device. The method further comprises receiving from the first communication device a message indicative of a confirmation or a rejection of the authentication of the user.

According to a third aspect of the invention there is provided a first communication device for supporting authentication of a user to a service provided by a second communication device. The first communication device comprises a processor and a memory. The memory having stored thereon instructions executable by the processor, wherein the instructions, when executed by the processor, cause the first communication device to send to the second communication device a request for accessing the service. The request comprises credentials of the user. The first communication device is further operative to receive inference biometric data of the user from the second communication device. The first communication device is further operative to determine whether the user can be authenticated using a machine learning, ML, model, trained for classifying biometric data of the user and the received inference biometric data as input. The first communication device is further operative to, in response thereto, send to the second communication device a message indicative of a confirmation or a rejection of the authentication of the user.

According to a fourth aspect of the invention, there is provided a second communication device for supporting authentication of a user to a service provided by the second communication device. The second communication device comprises a processor and a memory. The memory having stored thereon instructions executable by the processor, wherein the instructions, when executed by the processor, cause the second communication device to receive, from a first communication device, a request for accessing the service. The request comprises credentials of the user. The second communication device is further operative to obtain inference biometric data of the user from a sensor adapted to capture biometric data from the user, in response to a successful verification of the credentials of the user. The second communication device is further operative to send the inference biometric data to the first communication device. The second communication device is further operative to receive from the first communication device a message indicative of a confirmation or a rejection of the authentication of the user.

According to a fifth aspect of the invention, a computer program is provided. The computer program comprises instructions which, when run in a processing unit on a first communication device, cause the first communication device to carry out the method according to an embodiment of the first aspect of the invention.

According to a sixth aspect of the invention, a computer program product is provided. The computer program product comprises a computer readable storage medium on which a computer program according to the fifth aspect of the invention is stored.

According to a seventh aspect of the invention, a computer program is provided. The computer program comprises instructions which, when run in a processing unit on a second communication device, cause the second communication device to carry out the method according to an embodiment of the second aspect of the invention.

According to an eighth aspect of the invention, a computer program product is provided. The computer program product comprises a computer readable storage medium on which a computer program according to the seventh aspect of the invention is stored.

Certain embodiments may provide one or more of the following technical advantages. A user may be authenticated independently from the communication device and/or sensor used for capturing biometric data. Only the communication device, such as a smartphone, possessed by the user stores biometric data necessary to allow the user authentication. Users may adopt their devices for authentication and do not need to use additional devices such as tokens and smart cards. Advantageously, it is only the communication device possessed by the user which contains the ML model used in the authentication, from which it is not possible to reverse-engineer the biometric data.

### BRIEF DESCRIPTION OF THE DRAWINGS

For better understanding of the present disclosure, and to show more readily how the invention may be carried into effect, reference will now be made, by way of example, to the following drawings, in which:

FIG. 1 shows an example system comprising entities according to embodiments of the invention;

FIG. 2 shows a flowchart illustrating a method performed by a first communication device according to embodiments of the invention;

FIG. 3 shows a flowchart illustrating a method performed by a second communication device according to embodiments of the invention;

FIG. 4 shows messages exchanged between a first communication device and a second communication device according to embodiments of the invention;

FIG. 5 is a block diagram depicting a first communication device according to embodiments of the invention;

FIG. 6 is a block diagram depicting a second communication device according to embodiments of the invention; and

### DETAILED DESCRIPTION

Embodiments will be illustrated herein with reference to the accompanying drawings. These embodiments are provided by way of example so that this disclosure will be thorough and complete, and will fully convey the scope of the inventive concept to those skilled in the art.

Authentication solutions based on biometric data of a user, such as retinas, irises, voices, facial characteristics, and fingerprints, compare stored or previously captured (reference) biometric data of the user and live-captured biometric data of the user. The authentication solutions are usually tied to a specific sensor that needs to be the same for capturing the biometric data to store and for capturing the biometric data to use when the user needs to be authenticated. However, different devices with potentially different sensors may be used for capturing the reference biometric data and for capturing the biometric data to use for authentication the user when requesting access to a service. The different sensors may have different manufacturers and/or may use different software.

The solution disclosed herein makes it possible to obtain a solution for authenticating a user independent from the communication device and/or sensor used for capturing the biometric data. This is accomplished by decoupling a training phase of a machine learning (ML) model for supporting authentication of a user to a service and a running (or inference) phase of the ML model to authenticate the user. In the training phase, the ML model is trained using biometric data obtained from a first sensor. In the running phase, the ML model authenticates the user taking live-captured biometric data obtained from a second sensor as input. Specifically, this is achieved by a first communication device sending to a second communication device a request for the user to access a service, wherein the request comprises credentials of the user; receiving inference biometric data of the user from the second communication device; determining whether the user can be authenticated using a ML model trained for classifying biometric data of the user and the received inference biometric data as input; and in response thereto, sending to the second communication device a message indicative of a confirmation or a rejection of the authentication of the user.

In the present disclosure, the term “training biometric data” refers to biometric data of the user used as input to train a ML model. In contrast, the term “inference biometric data” refers to biometric data of the user used as input of the ML model after the training has been completed.

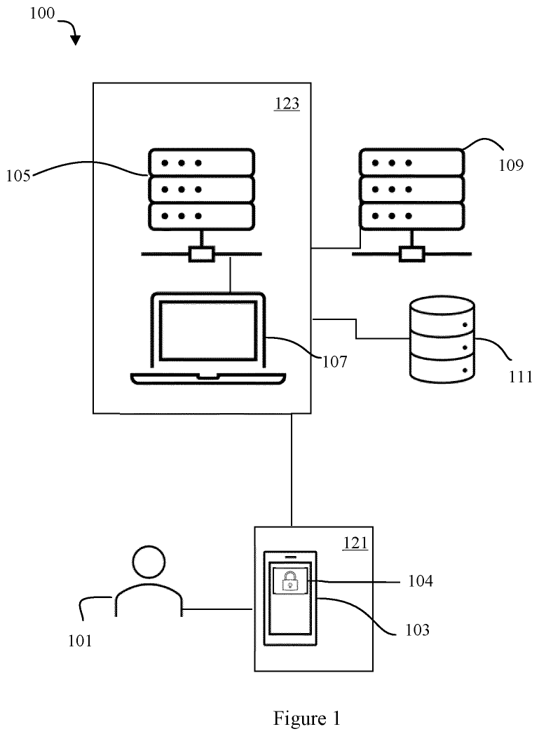

FIG. 1 shows an example system 100 wherein a solution according to embodiments of the invention may be implemented. The system 100 comprises a user device 103 running an application 104, a sign-in server 105 and a sign-in portal 107, an enrollment database 111, and a template ML factory 109.

In the example system 100, a user 101 wants to access a protected service provided by a sign-in server 105. The user requests the access via the user device 103, e.g., a smartphone or a tablet of the user 101. The user device 103 may comprise a sensor adapted to capture biometric data from the user, such as a fingerprint sensor (optical, capacitive, or ultrasonic scanner), a voice sensor (aka a microphone), an iris sensor, a camera, a heart-rate sensor. The user device 103 executes the application 104 which may communicate with a sign-in portal 107 that is an intermediate node between the application 104 and the sign-in server 105. The sign-in portal 107 is used for logging user credentials, such as username and password. The sign-in server 105 is an entity hosting the protected service that the user wants to access. Examples of services are websites, access to public transportation or buildings, banking, etc. Alternatively, the application 104 may communicate with the sign-in server 105 and log the user credentials in the sign-in server 105.

The template ML factory 109 is an entity wherein ML models for authenticating users are trained. A template is a trained ML model for authenticating a user. The enrollment database 111 is used for registering and storing the user information, such as user identification, identification of the ML model, and identification of the application 104.

The user device 103 and the template ML factory 109 may be implemented on a same communication device, referred as first communication device 121. The first communication device 121 may be any computing device with network connectivity, such as a smartphone, a tablet, or a smartwatch.

The sign-in server 105 and the sign-in portal 107 may be implemented on a same communication device, referred as second communication device 123. The second communication device 123 may be any computing device with network connectivity.

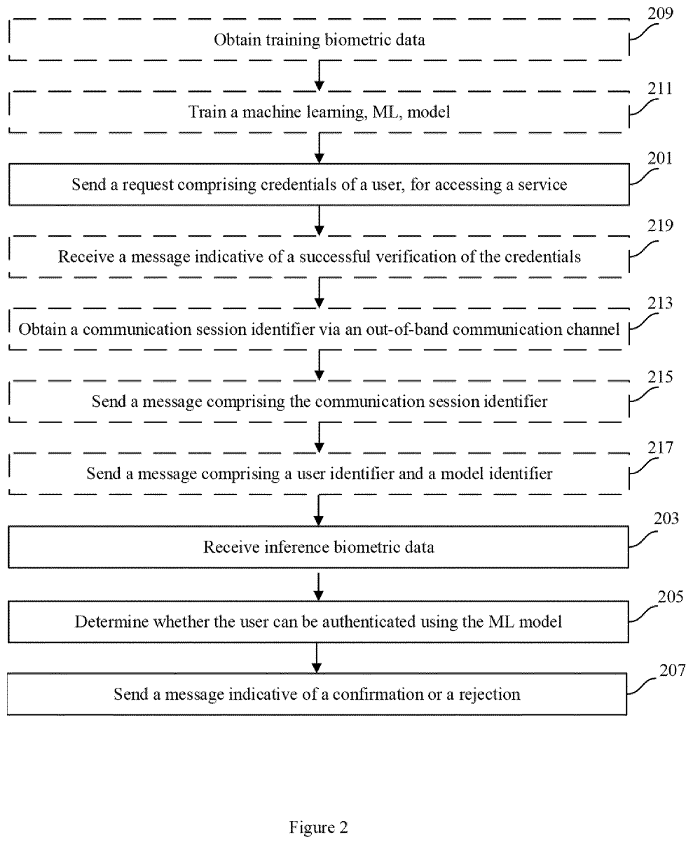

In the following, embodiments of a method 200 for supporting authentication of a user to a service provided by a second communication device 123 are described with reference to FIG. 2. The method 200 is performed by the first communication device 121.

The method comprises sending 201 to the second communication device 123 a request for accessing the service. The request may be a login request. The request comprises credentials of the user. Examples of credentials of the user comprise username and password. The method 200 may comprise receiving 219 a message indicative of a successful or unsuccessful verification of the credentials of the user from the second communication device 123.

The message is indicative of a successful verification if the sent credentials correspond to credentials previously registered and associated to an authorized user.

The message is indicative of an unsuccessful verification otherwise. The credentials previously registered and associated to the authorized user may be stored in the second communication device 123 or in a further communication device which the second communication device 123 communicates with.

The method 200 further comprises receiving 203 inference biometric data of the user from the second communication device 123. The received inference biometric data has been obtained by the second communication device 123 from a sensor adapted to capture biometric data from the user, in response to a successful verification of the credentials of the user. The sensor may be a device or a transducer, such as a camera, able to capture an image of a biometric trait such as face, iris, or fingerprint. The inference biometric data is provided as input to a ML model trained for classifying biometric data of the user.

The method 200 further comprises determining 205 whether the user can be authenticated using the ML model. The ML model may be a supervised ML model, such as k-nearest neighbors (K-NN), support vector machine (SVM), or convolution neural network (CNN). The ML model may be generated by obtaining 209 training biometric data of the user from a sensor adapted to capture biometric data of the user and by training 211 the ML model using the obtained training biometric data. If the sensor is a camera, the training biometric data of the user may comprise for example images comprising the face of the user. A pre-trained deep neural network such as an artificial neural network (ANN) may be used for automating the extraction of faces in the images.

If the sensor is a microphone, the training biometric data of the user may comprise for example raw data containing a recorded voice or a waveform of the recorded voice.

If the sensor is a fingerprint sensor, the training biometric data of the user may comprise images of the fingerprint acquired by the fingerprint sensor.

The sensor adapted to capture training biometric data of the user may be different from the sensor adapted to capture inference biometric data of the user. The training is executed on training biometric data not including sensor specific information, thus making the trained ML model independent from the sensor and able to authenticate the user with inference biometric data taken from different sensors of potentially different vendors. The training of the ML model may be performed offline. The trained ML model may have a time period of validity. Rather than updating the trained ML model with additional training cycles, a new ML model may be generated if the period of validity has expired.

The method 200 further comprises sending 207 to the second communication device 123 a message indicative of a confirmation or a rejection of the authentication of the user. A message indicative of a confirmation is sent if the ML model receiving as input the inference biometric data generates as output a label corresponding to the user or a label positively or negatively identifying the user (e.g., “yes” or “no”), otherwise a message indicative of a rejection is sent. In case of confirmation, the user is authorized to access the service, otherwise the access to the service is denied.

Before receiving 203 inference biometric data of the user from the second communication device 123, the method 200 may further comprise steps for setting up a session and verifying the user identity. For instance, the method 200 may further comprise obtaining 213 a communication session identifier via an out-of-band communication channel from the second communication device 123, and sending 215 a message comprising the communication session identifier to the second communication device 123. Preferably, the inference and training biometric data and the other messages exchanged between the first communication device 121 and the second communication device 123 are transmitted on a first communication channel, and the communication session identifier is received on a second communication channel which is different from the first communication channel, i.e., an out-of-band communication channel. Obtaining the communication session identifier via the out-of-band communication channel provides an additional security factor on top of the biometric recognition against attacks. The first communication channel may be a Wi-Fi or cellular connection, and the second channel may be a Bluetooth or NFC connection. Alternatively, the communication session identifier may be received via a visual communications channel, wherein the communication session identifier is encoded into a visual representation for display by the second communication device 123, such as a QR code. The communication session identifier may be obtained by the first communication device 121 using a camera to capture the encoded visual representation of the communication session identifier. After obtaining the communication session identifier, the first communication device 121 sends the communication session identifier to the second communication device 123. The second communication device 123 verifies the received communication session identifier to ensure that the first communication device 121 is allowed to access the service and initiates a real-time communication session with the first communication device 121. However, the verification of the received communication session identifier does not guarantee that the user using the first communication device 121 is the legitimate user, since a non-authorized user may be in possession of the first communication device 121 and attempt to perform the authentication. Therefore, the verification should be performed in combination with the determination whether the user can be authenticated using the ML model trained for classifying biometric data of the user.

The method 200 may further comprise, after initiating the real-time communication session, sending 217 a message comprising a user identifier identifying the user and a model identifier identifying the ML model to the second communication device 123. The user identifier, such as an alphanumeric sequence, is unique and may be assigned to the user or to an application running on the first communication device 121 implementing the method. The model identifier, such as an alphanumeric sequence, is unique and may be assigned to the ML model trained for classifying biometric data of the user. The user identifier and the model identifier may be generated when the user registers the application running on the first communication device 121 in the enrollment database 111 and the trained ML model is generated. The user identifier and the model identifier may be stored in the first communication device 121 and in the enrollment database 111 that may be implemented in the second communication device 123. When the real-time communication session is initiated, the user identifier and the model identifier are sent by the first communication device 121 to the second communication device 123. If the received user identifier and model identifier correspond to the user identifier and model identifier stored in the second communication device 123, the second communication device 123 successfully verifies that the user is using an authorized ML model.

It will be appreciated that the method 200 may comprise additional, alternative, or modified, steps in accordance with what is described throughout this disclosure. An embodiment of the method 200 may be implemented as a computer program 504 comprising instructions which when the computer program 504 is executed by the first communication device 121 cause the first communication device 121 to carry out the method 200 and become operative in accordance with embodiments of the invention described herein. The computer program 504 may be stored in a computer-readable data carrier, such as the memory 502. Alternatively, the computer program 504 may be carried by a data carrier signal, e.g., downloaded to the memory 502 via a network interface circuitry 503.

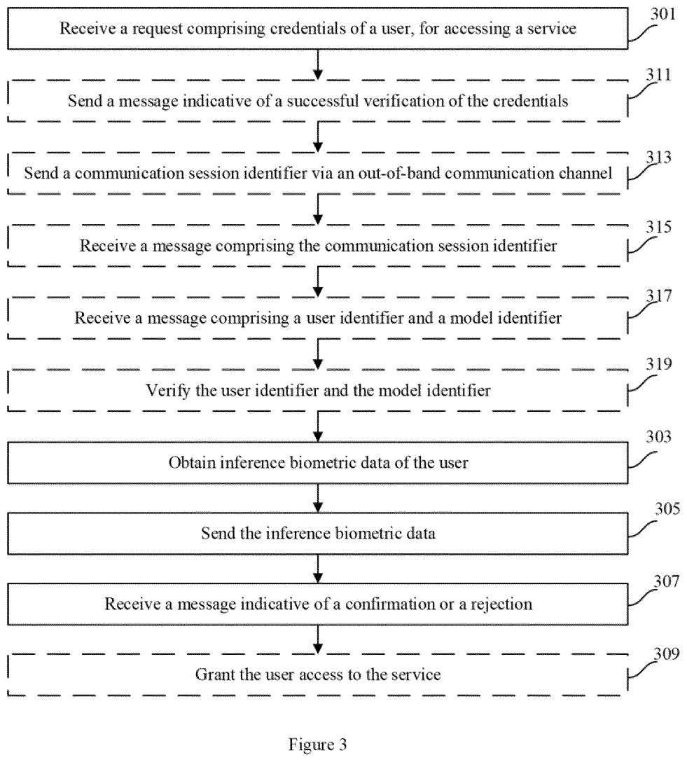

In the following, embodiments of a method 300 for supporting authentication of a user to a service provided by a second communication device 123 are described with reference to FIG. 3. The method 300 is performed by the second communication device 123.

The method 300 comprises receiving 301 from the first communication device 121, a request for accessing the service, wherein the request comprises credentials of the user. The second communication device 123 verifies if the received credentials correspond to credentials of a registered user. The second communication device 123 may comprise a database storing the credentials of registered users which are authorized to access the service, or the credentials of registered users may be stored in a further communication device or database accessible by the second communication device 123. The method 300 may further comprise sending 311 a message indicative of a successful or unsuccessful verification of the credentials of the user to the first communication device 121. The message is indicative of a successful verification if the received credentials correspond to the credentials of a registered user. The message is indicative of an unsuccessful verification otherwise.

The method 300 further comprises obtaining 303 inference biometric data of the user from a sensor adapted to capture biometric data from the user, in response to a successful verification of the credentials of the use.

The method 300 further comprises sending 305 the inference biometric data to the first communication device 121 and receiving 307 from the first communication device 121 a message indicative of a confirmation or a rejection of the authentication of the user. The method 300 may further comprise granting 309 the user access to the service, in response to receiving 307 the message indicative of the confirmation of the authentication of the user.

The method 300 may further comprise, before obtaining 303 the inference biometric data of the user from the sensor, sending 313 to the first communication device 121 a communication session identifier via an out-of-band communication channel. The method 300 may further comprise receiving 315 a message comprising the communication session identifier from the first communication device 121. Preferably, the inference and training biometric data and the other messages exchanged between the first communication device 121 and the second communication device 123 are transmitted on a first communication channel, and the communication session identifier is transmitted by the second communication device on a second communication channel which is different from the first communication channel, i.e., the out-of-band communication channel. Sending the communication session identifier via the out-of-band communication channel provides an additional security factor on top of the biometric recognition against attacks. The first communication channel may be a Wi-Fi or cellular connection, and the second channel may be a Bluetooth or NFC connection.

Alternatively, the communication session identifier may be transmitted 313 via a visual communications channel, by encoding the communication session identifier into a visual representation for display by the second communication device 123, such as a QR code. After obtaining the communication session identifier by the first communication device 121 from the second communication device 123, the first communication device 121 transmits the communication session identifier back to the second communication device 123 and the second communication device 123 verifies the received communication session identifier to ensure that the first communication device 121 is allowed to access the service and initiates a real-time communication session with the first communication device 121. However, the verification of the received communication session identifier does not guarantee that the user using the first communication device 121 is the legitimate user, since a non-authorized user may be in possession of the first communication device 121 and attempt to perform the authentication. Therefore, the verification should be performed in combination with the determination whether the user can be authenticated using the ML model trained for classifying biometric data of the user.

The method 300 may further comprise, after initiating the real-time communication session, receiving 317 from the first communication device 121 a message comprising a user identifier identifying the user and a model identifier identifying a ML model trained for classifying biometric data of the user, and verifying 319 the user identifier and the model identifier. The user identifier, such as an alphanumeric sequence, is unique and may be assigned to the user or to an application running on the first communication device implementing the method. The model identifier, such as an alphanumeric sequence, is unique and may be assigned to the ML model trained for classifying biometric data of the user. The user identifier and the model identifier may be generated when the user registers the application running on the first communication device 123 in the enrollment database 111 and the trained ML model is generated. The user identifier and the model identifier may be stored in the first communication device 121 and in the enrollment database 111 that may be implemented in the second communication device 123. When the real-time communication session is initiated, the user identifier and the model identifier are sent by the first communication device 121 to the second communication device 123. If the received user identifier and model identifier correspond to the user identifier and model identifier stored in the second communication device 123, the second communication device 123 successfully verifies that the user is using an authorized ML model.

The inference biometric data of the user may be obtained 303 in response to a successful verification of the user identifier and the model identifier.

It will be appreciated that the method 300 may comprise additional, alternative, or modified, steps in accordance with what is described throughout this disclosure. An embodiment of the method 300 may be implemented as a computer program 604 comprising instructions which when the computer program 604 is executed by the second communication device 123 cause the second communication device 123 to carry out the method 300 and become operative in accordance with embodiments of the invention described herein. The computer program 604 may be stored in a computer-readable data carrier, such as a memory 602. Alternatively, the computer program 604 may be carried by a data carrier signal, e.g., downloaded to the memory 602 via a network interface circuitry 603.

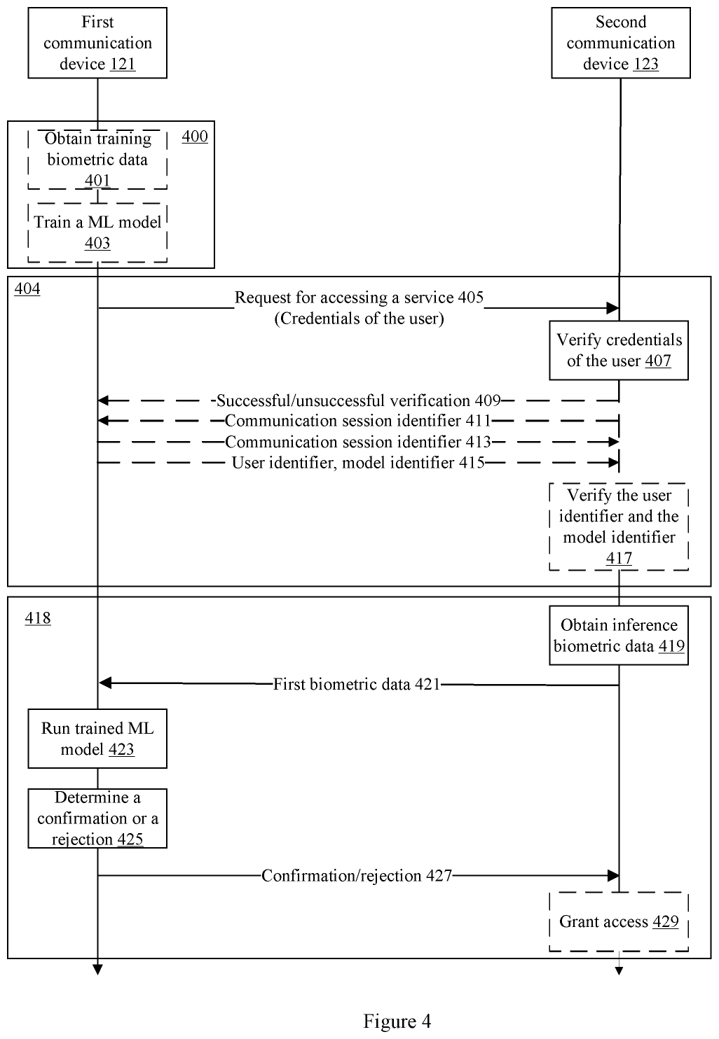

FIG. 4 shows an exchange of messages between the first communication device 121 and the second communication device 123, and operations performed according to embodiments of the invention. Three phases may be identified: a training phase 400 that is performed once or very rarely, a session setup phase 404, and a live session phase 418, that are performed at every authenticated session.

The training phase 400 comprises obtaining 209, 401 by the first communication device 121 training biometric data, and training 211, 403 by the first communication device 121, a ML model for authenticating a user which has requested to access a service provided by the second communication device 123.

Specifically, in the training phase 400, the first communication device 121, e.g., smartphone, tablet, etc, runs an application 104 implementing the method 200 described before. A unique identifier called “user-id” or “app-id” is assigned to the application 104. The first communication device 121 is configured to capture training biometric data of the user via, e.g., a camera or fingerprint reader. The first communication device 121 transmits the captured training biometric data of the user to an entity (template ML factory 109 in FIG. 1) which executes an ML algorithm. The entity 109 running the ML algorithm may be implemented on the first communication device 121 or on a third communication device.

After obtaining 209, 401 the training biometric data, the template ML factory 109 trains 211, 403 a ML model for authenticating the user with the obtained biometric data of the user. A unique identifier called “template-id” is assigned to the trained ML model. The ML model may be trained under the supervision of an approver, that may be the user itself for self-approval or a trusted entity. The approver checks the biometric samples provided by the user as input for granting the identity. If the template ML factory 109 is hosted on a third communication device, the trained ML model is transmitted to the first communication device 121 and deleted from the template ML factory 109.

The user-id and template-id are saved in an enrollment database 111, wherein the enrollment database 111 may be hosted on the second communication device 123.

In the following, the session setup phase 404 is described in more detail. The first communication device 121 transmits 201, 405 a request for accessing the service, wherein the request comprises credentials of the user, such as username and password. The second communication device 123 verifies 407 the received credentials of the user. The second communication device 123 transmits 311, 409 to the first communication device 121 a message indicating a successful or an unsuccessful verification based on the verification of the credentials 407. If the message indicating a successful verification is sent, the second communication device 121 further transmits 313, 411 a message comprising a communication session identifier via an out-of-band channel. Then, the first communication device 121 sends 215, 413 the received communication session identifier to the second communication device 123 and if the received session communication identifier is verified by the second communication device 123, the real-time communication session is initiated. The first communication device 121 transmits 217, 415 to the second communication device 123 the user identifier and model identifier. The second communication device 123 verifies 417 the received user identifier and model identifier comparing the received user identifier and model identifier with the user-id and template-id saved in the enrollment database 111. If the verification of the received user identifier and model identifier is successful, the live session phase 418 is initiated.

In the live session phase 418, the second communication device 123 obtains 303, 419 from a sensor inference biometric data of the user, such as images captured by certified and/or allowed sensors. The obtained inference biometric data is sent 305, 421 by the second communication device 123 to the first communication device 121. The first communication device 121 executes 423 the trained ML model using the received inference biometric data as input and determines 205, 425 a confirmation or rejection of the user authentication request based on the output of the trained ML model. The first communication device 121 transmits 207, 427 a message indicative of the confirmation or the rejection to the second communication device 123. If the second communication device 123 receives the message indicative of the confirmation, the second communication device 123 grants 309, 429 the access to the service to the user. Otherwise, the second communication device 123 does not grant the access to the service to the user.

After a pre-determined time or after inactivity of the user the real-time communication session may be terminated.

An example scenario in which the present invention may be practiced is in relation to a public transport infrastructure equipped with facial recognition of passengers to provide a simplified ticketing process and passenger management. Specifically, a passenger needs to pass a security gate with facial recognition before embarking. The security gate may comprise a display and a camera. The security gate may be comprised in a second communication device 123 as described above. The passenger has an application 104 running on its own smartphone, i.e., a first communication device 121, implementing the method described above. In case of first access, the passenger first registers to an enrollment database 111 and obtains a trained ML model according to embodiments of the invention. The security gate generates a temporary unique communication session identifier for accepting an incoming connection and starts a communication session with the smartphone. The communication session identifier is encoded in a QR code displayed on the display. The passenger captures the QR code with the camera of his smartphone, the application decodes the QR code and sets up a communication session with the security gate by sending the communication session identifier, user identification and ML model identification. The security gate verifies the received communication session identifier, user identification, and ML model identification, with information stored in the enrollment database 111 according to embodiments of the invention.

If the verification is successful, the camera of the security gate captures an image of the passenger, at least of the facial region, and the captured image is sent to the smartphone of the passenger. The application 104 runs the trained ML model with the received image as input. The output of the trained ML model, i.e., a confirmation or a rejection of the authentication of the passenger, is sent to the security gate. If the security gate receives a confirmation the gate opens, otherwise the gate stays closed. After a pre-determined time or after some inactivity the real-time communication session may be terminated.

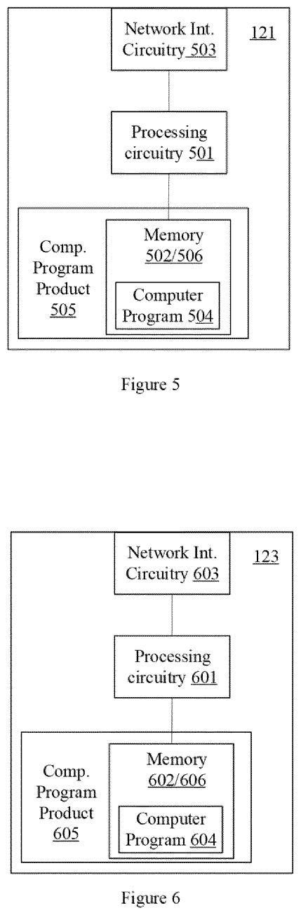

FIG. 5 is a block diagram illustrating an embodiment of the first communication device 121, comprising a processor circuitry 501, a computer program product 505 in the form of a computer readable storage medium 506, such as a memory 502, and a network interface circuitry 503.

The processing circuitry 501 may comprise one or more processors, such as Central Processing Units (CPUs), microprocessors, application processors, application-specific processors, Graphics Processing Units (GPUs), and Digital Signal Processors (DSPs) including image processors, or a combination thereof, and the memory 502 comprising a computer program 504 comprising instructions. When executed by the processor(s), the instructions cause the first communication device 121 to become operative in accordance with embodiments of the invention described herein, in particular with reference to FIG. 2. The memory 502 may, e.g., be a Random-Access Memory (RAM), a Read-Only Memory (ROM), a Flash memory, or the like. The computer program 504 may be downloaded to the memory 502 by means of a network interface circuitry 503, as a data carrier signal carrying the computer program 504. The network interface circuitry 503 may comprise one or more of a cellular modem (e.g., GSM, UMTS, LTE, 5G, or higher generation), a WLAN/Wi-Fi modem, a Bluetooth modem, an Ethernet interface, an optical interface, or the like, for exchanging data between the first communication device 121 and other computing devices, communications devices, a radio-access network, and/or the Internet. The processing circuitry 501 may alternatively or additionally comprise one or more Application-Specific Integrated Circuits (ASICs), Field-Programmable Gate Arrays (FPGAs), or the like, which are operative to cause the first communication device 121 to become operative in accordance with embodiments of the invention described herein.

FIG. 6 is a block diagram illustrating an embodiment of the second communication device 123, comprising a processor circuitry 601, a computer program product 605 in the form of a computer readable storage medium 606, such as a memory 602, and a network interface circuitry 603.

The processing circuitry 601 may comprise one or more processors, such as CPUs, microprocessors, application processors, application-specific processors, GPUs, and DSPs including image processors, or a combination thereof, and the memory 602 comprising a computer program 604 comprising instructions. When executed by the processor(s), the instructions cause the second communication device 123 to become operative in accordance with embodiments of the invention described herein, in particular with reference to FIG. 3. The memory 602 may, e.g., be a RAM, a ROM, a Flash memory, or the like. The computer program 604 may be downloaded to the memory 602 by means of a network interface circuitry 603, as a data carrier signal carrying the computer program 604. The network interface circuitry 603 may comprise one or more of a cellular modem (e.g., GSM, UMTS, LTE, 5G, or higher generation), a WLAN/Wi-Fi modem, a Bluetooth modem, an Ethernet interface, an optical interface, or the like, for exchanging data between the second communication device 123 and other computing devices, communications devices, a radio-access network, and/or the Internet. The processing circuitry 601 may alternatively or additionally comprise one or more ASICs, FPGAs, or the like, which are operative to cause the second communication device 123 to become operative in accordance with embodiments of the invention described herein.

The first communication device 121 and the second communication device 123 may communicate through a subscription protocol, such as message queuing telemetry transport, MQTT, protocol, Open Platform Communications Unified Architecture (OPC-UA), Data Distribution Service (DDS), or utilizing any one of a number of transfer protocols, e.g., frame relay, internet protocol (IP), transmission control protocol (TCP), user datagram protocol (UDP), hypertext transfer protocol (HTTP), or by using Remote Procedure Call (RPC) protocols, such as gRPC. The transport layer security (TLS) protocol may be used to ensure security requirements.

1. A method for supporting authentication of a user to a service provided by a second communication device, the method being performed by a first communication device, the method comprising:
sending to the second communication device a request for accessing the service, wherein the request comprises credentials of the user;
receiving inference biometric data of the user from the second communication device;
determining whether the user can be authenticated using a machine learning, ML, model trained for classifying biometric data of the user and the received inference biometric data as input; and
in response thereto, sending to the second communication device a message indicative of a confirmation or a rejection of the authentication of the user.

2. The method according to claim 1, further comprising:
obtaining training biometric data of the user from a sensor adapted to capture training biometric data of the user;
training the ML model using the obtained training biometric data.

3. The method according to claim 1, further comprising:
obtaining a communication session identifier via an out-of-band communication channel from the second communication device;
sending a message comprising the communication session identifier to the second communication device.

4. The method according to claim 3, wherein the obtaining a communication session identifier comprises using a camera to capture an encoded visual representation of the communication session identifier.

5. The method according to claim 1, further comprising:
sending a message comprising a user identifier identifying the user and a model identifier identifying the ML model to the second communication device.

6. The method according to claim 1, further comprising:
receiving a message indicative of a successful verification of the credentials of the user from the second communication device.

7. A method for supporting authentication of a user to a service provided by a second communication device, the method being performed by the second communication device, the method comprising:
receiving, from a first communication device, a request for accessing the service, wherein the request comprises credentials of the user;
obtaining inference biometric data of the user from a sensor adapted to capture biometric data from the user, in response to a successful verification of the credentials of the user;
sending the inference biometric data to the first communication device;
receiving from the first communication device a message indicative of a confirmation or a rejection of the authentication of the user.

8. The method according to claim 7, further comprising:
in response to receiving the message indicative of the confirmation of the authentication of the user, granting the user access to the service.

9. The method according to claim 7, further comprising:
sending a message indicative of a successful verification of the credentials of the user to the first communication device.

10. The method according to claim 7, further comprising:
sending, to the first communication device, a communication session identifier via an out-of-band communication channel;
receiving a message comprising the communication session identifier from the first communication device.

11. The method according to claim 10, wherein the sending a communication session identifier comprises displaying an encoded visual representation of the communication session identifier.

12. The method according to claim 7, further comprising
receiving, from the first communication device, a message comprising a user identifier identifying the user and a model identifier identifying a machine learning, ML, model trained for classifying biometric data of the user;
verifying the user identifier and the model identifier.

13. The method according to claim 12, wherein the obtaining inference biometric data of the user comprises obtaining inference biometric data of the user in response to a successful verification of the user identifier and the model identifier.

14. A first communication device for supporting authentication of a user to a service provided by a second communication device, the first communication device comprising a processor and a memory, the memory having stored thereon instructions executable by the processor, wherein the instructions, when executed by the processor, cause the first communication device to:
send to the second communication device a request for accessing the service, wherein the request comprises credentials of the user;
receive inference biometric data of the user from the second communication device;
determine whether the user can be authenticated using a machine learning, ML, model, trained for classifying biometric data of the user and the received inference biometric data as input; and
in response thereto, send to the second communication device a message indicative of a confirmation or a rejection of the authentication of the user.

15. The first communication device according to claim 14, wherein the instructions, when executed by the processor, cause the first communication device to:
obtain training biometric data of the user from a sensor adapted to capture biometric data from the user;
train the ML model using the obtained training biometric data.

16. The first communication device according to claim 14, wherein the instructions, when executed by the processor, cause the first communication device to:
obtain a communication session identifier via an out-of-band communication channel from the second communication device;
send a message comprising the communication session identifier to the second communication device.

17. The first communication device according to claim 16, wherein the instructions, when executed by the processor, cause the first communication device to:
obtain the communication session identifier using a camera to capture an encoded visual representation of the communication session identifier.

18. The first communication device according to claim 14, wherein the instructions, when executed by the processor, cause the first communication device to:
send a message comprising a user identifier identifying the user and a model identifier identifying the ML model to the second communication device.

19. The first communication device according to claim 14, wherein the instructions, when executed by the processor, cause the first communication device to:
receive a message indicative of a successful verification of the credentials of the user.

20-32. (canceled)
